(19) United States
(12) Patent Application Publication
(10) Pub. No.: US 2025/0254402 A1
(43) Pub. Date: Aug. 7, 2025

(54) SYSTEMS AND METHODS FOR GENERATING SPORTS MEDIA CONTENT FOR AN INTERACTIVE DISPLAY

(71) Applicant: STATS LLC, Chicago, IL (US)

(72) Inventors: Niall Hendry, London (GB); Kevin Allinson, Yarm (GB); Anthony Borsumato, Cambridge (GB); Alex Lanegger, Porto (PT); Christian Marko, Graz (AT); Patrick Joseph Lucey, Chicago, IL (US)

(73) Assignee: STATS LLC, Chicago, IL (US)

(21) Appl. No.: 19/041,124

(22) Filed: Jan. 30, 2025

Related U.S. Application Data
(60) Provisional application No. 63/554,426, filed on Feb. 16, 2024.
(60) Provisional application No. 63/549,225, filed on Feb. 2, 2024.

(51) Int. Cl. H04N 21/81; G06N 20/00; G06Q 30/0203; G06Q 30/0251; G06Q 30/0601; H04N 21/431; H04N 21/45; H04N 21/466; H04N 21/472

(52) U.S. Cl. CPC H04N 21/8133; G06N 20/00; G06Q 30/0203; G06Q 30/0269; G06Q 30/0631; H04N 21/4316; H04N 21/4532; H04N 21/4662; H04N 21/472

(57) ABSTRACT

A method may include receiving data for a game, the data comprising at least one of tracking data or event data. The method may include determining an occurrence of a trigger event within the game based on the data for the game. The method may include providing the data for the game and the occurrence of the trigger event to a first machine learning (ML) model, where the first ML model is trained to generate a graphic based on the data for the game and the occurrence of the trigger event. The method may include receiving, from the first ML model, the graphic, and generating a visual element including the graphic for presentation within a user interface. The visual element may be configured to include an interactive element or be positioned adjacent to the interactive element within the user interface.

### CROSS-REFERENCE TO RELATED APPLICATIONS

This patent application claims the benefit of priority to U.S. Provisional Patent Application No. 63/549,225, filed on Feb. 2, 2024, and U.S. Provisional Patent Application 63/554,426, filed on Feb. 16, 2024, both of which are incorporated by reference herein in their entireties.

### TECHNICAL FIELD

Various embodiments of the present disclosure relate generally to generating sports media content and, more particularly, to systems and methods for generating one or more sports media stories for an interactive display.

### INTRODUCTION

Digital media associated with sports (e.g., new articles regarding soccer games, images of soccer players, or the like) are widely available on webpages, websites, portals, and applications. However, inefficient, manual techniques are often used to generate such digital media.

Unless otherwise indicated herein, the techniques and information described in this section are not prior art to the claims in this application and are not admitted to be prior art, or suggestions of the prior art, by inclusion in this section.

### SUMMARY

A method may comprise receiving, by a computing system, data for a game, the data comprising at least one of tracking data or event data. The method may comprise determining, by the computing system, an occurrence of a trigger event within the game based on the data for the game. The method may comprise providing the data for the game and the occurrence of the trigger event to a first machine learning model, where the first machine learning model is trained to generate a graphic based on the data for the game and the occurrence of the trigger event. The method may comprise receiving, from the first machine learning model, the graphic based on the data for the game and the occurrence of the trigger event within the game. The method may also comprise generating, by the computing system, a visual element including the graphic for presentation within a user interface, the visual element being configured to include an interactive element or be positioned adjacent to the interactive element within the user interface.

A non-transitory computer readable medium may comprise one or more sequences of instructions, which, when executed by one or more processors, causes a computing system to perform operations. The operations may comprise receiving, by the computing system, data for a game, the data comprising at least one of tracking data or event data. The operations may comprise determining, by the computing system, an occurrence of a trigger event within the game based on the data for the game. The operations may comprise providing the data for the game and the occurrence of the trigger event to a first machine learning model, where the first machine learning model is trained to generate a graphic based on the data for the game and the occurrence of the trigger event. The operations may comprise receiving, from the first machine learning model, the graphic based on the data for the game and the occurrence of the trigger event within the game. The operations may also comprise generating, by the computing system, a visual element including the graphic for presentation within a user interface, the visual element being configured to include an interactive element or be positioned adjacent to the interactive element within the user interface.

A computing system may comprise a processor and a memory having programming instructions stored thereon, which, when executed by the processor, causes the computing system to perform operations. The operations may comprise receiving, by the computing system, data for a game, the data comprising at least one of tracking data or event data. The operations may comprise determining, by the computing system, an occurrence of a trigger event within the game based on the data for the game. The operations may comprise providing the data for the game and the occurrence of the trigger event to a first machine learning model, where the first machine learning model is trained to generate a graphic based on the data for the game and the occurrence of the trigger event. The operations may comprise receiving, from the first machine learning model, the graphic based on the data for the game and the occurrence of the trigger event within the game. The operations may also comprise generating, by the computing system, a visual element including the graphic for presentation within a user interface, the visual element being configured to include an interactive element or be positioned adjacent to the interactive element within the user interface.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 depicts graphical representations, which include key statistics related to the use of sports media stories to consume content, according to example embodiments.

FIG. 3 depicts a user's sports media platform display, including icons to access the sports media stores discussed herein, according to an example embodiment.

FIG. 4 depicts various aspects of an interactive display, according to an example embodiment.

FIG. 5 depicts various aspects of an interactive display, according to example embodiments.

FIG. 6 depicts a flow diagram of a method for generating an interactive display for a sports content data stream, according to example embodiments.

FIG. 7 depicts a flow diagram of a method for generating an interactive display for a sports content data stream, according to example embodiments.

FIG. 8 depicts a flow diagram of a method for generating an interactive display for a sports content data stream with additional user inputs, according to an example embodiment.

FIG. 9 depicts a flow diagram of a method for generating an interactive display for a sports content data stream with additional user inputs, according to an example embodiment.

FIG. 10A depicts inputs and output displays of sports content data stream being presented to a user, according to an example embodiment.

FIG. 10B depicts inputs and output displays of sports content data stream being presented to a user, according to an example embodiment.

FIG. 11 depicts an input and output display of a sports content data stream being presented to a user, according to an example embodiment.

FIG. 12 depicts a series of recommended sports content data streams for display based on user interactions, according to an example embodiment.

FIG. 13 depicts a flow diagram of a method for generating a story, according to example embodiments.

FIG. 14 depicts a flow diagram for training a machine learning model, according to example embodiments.

FIG. 15A is a block diagram illustrating a computing device, according to example embodiments.

FIG. 15B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Systems and techniques disclosed herein are directed to generating and outputting sports media content (e.g., a sports media story) for an interactive platform using one or more machine learning models or templates. Such content may be one or more of video (e.g., video data), audio (e.g., audio data) optionally integrated with the video, one or more interactive elements, or content threads, for example. Further, such content may include one or more graphics based on statistic(s) associated with sporting event data, images associated with sporting event data, and/or the like, for example. As used herein, an “interactive element” may refer to (or include) one or more advertisements, market-based prediction opportunities (e.g., market-based prediction offers or market-based prediction options), surveys, polls, questionnaires, games, links (e.g., hyperlinks), buttons, calls to action, or the like. In some embodiments, the sports media content may be generated based on integrating sports event data with user data, such that when the sports media content is provided to a user via the interactive platform, the sports media content is relevant to the user. Further, in some embodiments, one or more market-based prediction offers may be provided to a user based on a sports action (or sports event data) and may be based on user data such that the market-based prediction offer(s) are relevant to the user. A market-based prediction offer may be generated and displayed via the interactive platform (e.g., a sports media platform, a social media platform, an interactive display, or interactive user interface) as a sports media story or adjacent to a sports media story, based on both the occurrence of the sports action and a corresponding user attribute determined based on the user data. In some aspects, a sports media story (also referred to herein as a “story” or “visual element”) may refer to graphical content that includes one or more of an image, video, audio, text, and/or an interactive element. Accordingly, systems and techniques disclosed herein are directed to generating sports media content, such as sports media stories, using one or more machine learning models or templates, where the sports media content may be user-specific and based on sports action(s) associated with at least one sporting event. In some aspects, such systems and techniques may be used to automatically and efficiently engage audiences (e.g., users who view the sports media content via an interactive display or environment), increase the dwell time of the audiences, and monetize the sports media content.

In some aspects, systems and techniques disclosed herein are directed to determining and displaying user-relevant sports media stories (or other sports media content such as user-relevant content streams) that are more relevant to a user in comparison to general social media content that may not associate sporting event data with user data. Such systems and techniques improve existing technology by utilizing additional data streams (e.g., user data and event data) to generate an interactive display and stories related to live sports content, or to generate other sports media content such as user-relevant content streams. By associating and using these additional data streams, displayed content is customized (or personalized) to each user or a group of users, based on real-time event data, such that less relevant content (e.g., content that does not meet a user relevance threshold) may be omitted. Omitting such less relevant content reduces the computational resources expended to generate, store, display, and/or track such less relevant content. For example, omitting less relevant content reduces the consumption of interface space associated with a user interface (e.g., by only displaying relevant content).

The disclosed systems and techniques also include improvements to machine learning. For instance, certain aspects relate to determining intentional and contextual information from a user input that may improve the performance, accuracy, and results of information to be mapped to sports-related data. In doing so, disclosed systems and techniques provide improvements relative to existing solutions.

As used herein, a “story” (also referred to as a “visual element” or a “sports media story”) may refer to graphical content that includes one or more of an image, video, audio, text, and/or an interactive element. In some aspects, a story may be displayed and/or shared by a user with other users across a platform, a sports media platform and/or other social media platform. The graphical content may be shared publicly or privately.

In some aspects, sports media stories may be generated based on live or recent sporting events and may be related to one or more teams, players, sports, and/or the like. The sports media stories may be of a digestible duration (e.g., between approximately 1 and 120 seconds) each. Each sports media story of a series of sports media stories may include content (e.g., videos, images, graphics, etc.) which may be portions of a video stream of a sporting event or may be populated based on sports statistics associated with one or more sporting events, teams, players, and/or the like.

In some aspects, sports media stories may be automatically generated based on sports event data (also referred to herein as “event data”) and/or tracking data, as discussed herein. The sports event data and/or tracking data may be input to a machine learning model trained to automatically output content and/or statistics based on the event data and/or tracking data. The output from the machine learning model may be converted into one or more sports media stories and provided to a user via a sports media platform.

Additionally, user interactions (e.g., time a user spends viewing an interactive display, a touch (e.g., of a button or link), a click, a selection, or the like) may be captured and processed by the disclosed computing system to determine aspects of the interactive display and/or sports media stories. Such aspects may include how the interactive display and/or sports media stories are displayed within a user interface (e.g., positioning within the user interface), when they are displayed (e.g., after a user interaction and/or in conjunction with real-time sports event data, and the like), what content is displayed (e.g., within the interactive display and/or sports media stories), and the like. The interactive display and/or sports media stories may be updated and/or generated “on-the-fly” by the computing system, based on the captured user interactions. In an example, if a user places a market prediction via the interactive display and/or a sports media story, additional related and/or relevant content may be presented to the user via the interactive display, sports media story, or by the presentation of additional sports media stories determined to be relevant to the user interaction. The interactive display and/or sports media stories may therefore be tailored to each unique user, based on user-specific input.

As used herein, a sports content stream (also referred to herein as a “content stream” or “user-relevant content stream”) may refer to a scrollable stream of sports media stories, and/or distinct sport information cards that may be updated in real time based on sports events. In some aspects, a sports content stream may include graphical or textual content that is displayed and/or shared by a user with other users across a sports media platform or other social media platform or computer application. The graphical content may be shared publicly or privately, and may include graphics (e.g., having sports based statistics or information), video, audio, and/or other content, such as one or more interactive elements. In some embodiments, one or more interactive graphics may be embedded as clickable or scrollable elements in a sports content stream. As used herein, a “sports information card” may refer to a distinct set of event data, tracking data, statistics, summaries, and/or the like, configured to be presented in graphical or textual (e.g., dialogue) form within a sports content stream (or user interface). A user may be able to access such sports information cards in a sequential format. The sequential format may be a chronological format (e.g., based on when a sporting action or event occurs), or may be a format based on relevancy of a sporting action or event to a user, scale of sporting event or action, and/or based on an algorithm or machine learning output configured to output a sequence of sports information cards that may be most relevant to a given user.

As used herein, a content stream may be or may include a sports media story that may include real-time or historical event data represented in graphical form (e.g., as output by a machine learning model, as discussed herein). Multiple sports media stories may be provided in continuous succession. Each sports media story may include visual content that is displayed for a predetermined or dynamically determined time. An expiration of time associated with a first sports media story may trigger a subsequent sports media story (e.g., with or without user input).

A sports content stream may dynamically update based on event data or other data. For example, first content of a sports content stream (e.g., a first sports information card, a first sports media story, etc.) available to a user may be replaced by an updated content (e.g., whether or not the user views the first content). The first content may be updated based on updated event actions associated with a sporting event. Accordingly, content in a sports content stream may automatically be removed or replaced if the content, statistics, graphics, or the like (e.g., associated with a story) are outdated or inaccurate based on event actions associated with a sporting event.

In some aspects, a sports content stream may be generated based on live or recent sporting events and may be related to a plurality of teams, players, sports, and/or the like. Each sports content stream may be of a digestible duration (e.g., between approximately 1 and 120 seconds). Further, each sports media story of a series of sports media stories may include content (e.g., videos, images, graphics, etc.) which may be portions of a video stream of a sporting event or may be populated based on sports statistics associated with one or more sporting events, teams, players, and the like.

In some aspects, a sports content stream may be automatically generated based on sports event data and/or tracking data, as discussed herein. The sports event data and/or tracking data may be input into a machine learning model trained to automatically output content and/or statistics based on the event data and/or tracking data. In some embodiments, the output(s) from the machine learning model may be converted into sport information cards and/or sports media stories and provided to a user via a sports content stream.

Additionally, user interactions (e.g., time a user spends viewing an interactive display, a touch (e.g., of a button or link), a click, a selection, or the like) may be captured and processed by the disclosed computing system to determine aspects of the interactive display and/or sports content stream. Such aspects may include how the interactive display and/or sports content stream are displayed within a user interface (e.g., positioning within the user interface), when they are displayed (e.g., after a user interaction and/or in conjunction with real-time sports event data, and the like), what content is displayed (e.g., within the interactive display and/or sports content stream), and the like. The interactive display and/or sports content stream may therefore be updated and/or generated “on-the-fly” by the computing system, based on the captured user interactions. In an example, if a user places a market prediction via the interactive display and/or a sports content stream, additional related and/or relevant content may be presented to the user via the interactive display, sports content stream, or by the presentation of additional threads within the sports content stream determined to be relevant to the user interaction. The interactive display and/or sports content stream may therefore be tailored to each unique user, based on user-specific input.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graph neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In some embodiments, a machine learning model may be a generative machine learning model. Such a machine learning model (or generative artificial intelligence (AI) applications) may focus on the task of using text to generate an image, video, or audio (or a combination of an image, video, and/or audio). This is done by using generative AI techniques to learn a mapping from one modality to another (e.g., from text to an image, video, and/or audio, or the like). The power of this technology is also the conversational aspect, where refinements of an initial text description may occur to improve an output (e.g., an image, video, audio, and/or text).

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

Further, while various aspects are discussed with respect to soccer (e.g., generating tracking data relating to a soccer play during a match), such aspects are described merely as illustrative examples. Disclosed techniques are by no means limited to soccer. For example, the present aspects can be implemented for other sports or activities, such as football (e.g., American football), basketball, baseball, hockey, cricket, rugby, tennis, team sports, individual sports, and so forth.

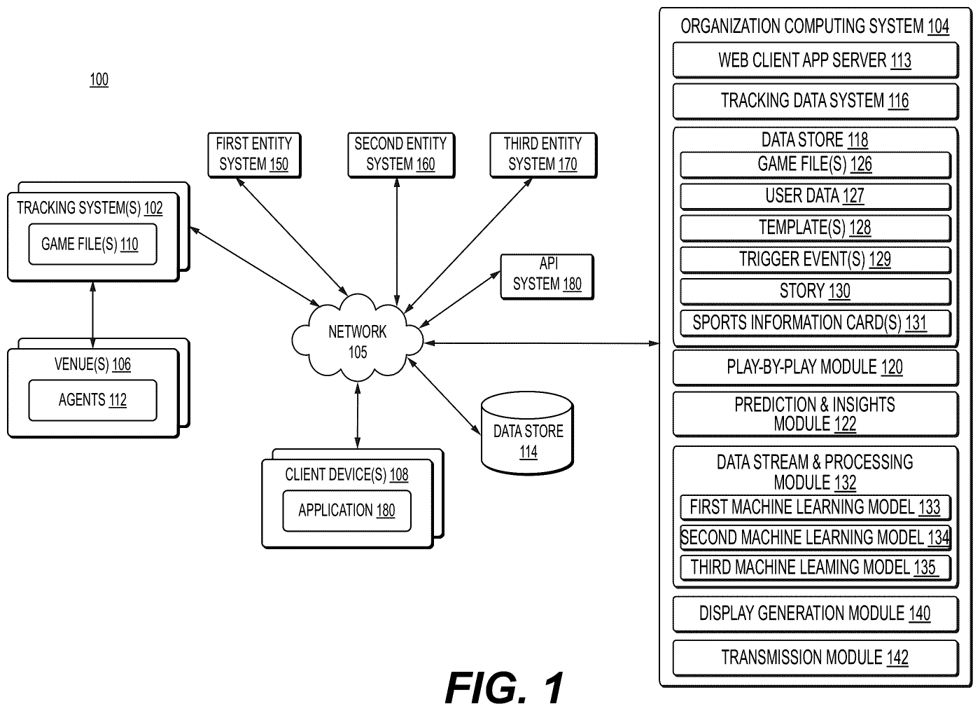

FIG. 1 is a block diagram illustrating a computing environment 100, according to example embodiments. The computing environment 100 may include a tracking system 102, a first entity system 150, a second entity system 160, a third entity system 170, an application programming interface (API) system 180, a data store 114, an organization computing system 104, and one or more client devices 108, communicating via a network 105. In some embodiments, the computing environment 100 may be an embodiment of the environment 100 described in U.S. Provisional Patent Application No. 63/549,225, filed on Feb. 2, 2024, and/or U.S. Provisional Patent Application 63/554,426, filed on Feb. 16, 2024, both of which are incorporated by reference herein.

The network 105 may be of any suitable type, including individual connections via the Internet, such as cellular or Wi-Fi networks. In some embodiments, the network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections, which may be encrypted or otherwise secured. In some embodiments, however, the information being transmitted may be less personal, and therefore, the network connections may be selected for convenience over security.

The network 105 may include any type of computer networking arrangement used to exchange data or information. For example, the network 105 may be the Internet, a private data network, virtual private network using a public network and/or other suitable connection(s) that enables components of the computing environment 100 to send and receive information between components of computing environment 100.

The tracking system 102 may be positioned in a venue 106 and/or may be in communication (e.g., electronic communication, wireless communication, wired communication, etc.) with the venue 106. For example, the venue 106 may be configured to host a sporting event that includes one or more agents 112 (e.g., players, objects, or the like). The tracking system 102 may be configured to capture the motions of one or more agents (e.g., players) on the playing surface, as well as one or more other agents of relevance (e.g., ball, puck, referees, etc.). In some embodiments, the tracking system 102 may be an optically-based system using, for example, fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects of relevance. Utilization of such a tracking system (e.g., the tracking system 102) may result in many different camera views of the playing surface (e.g., high sideline view, free-throw line view, huddle view, face-off view, end zone view, etc.).

In some embodiments, the tracking system 102 may be used for a broadcast feed of a given match. For example, the tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, a game file 110 may further be augmented with other event information corresponding to event data, such as, but not limited to, game event information (pass, made shot, turnover, etc.) and context information (current score, time remaining, etc.). Event data may be automatically identified using a machine learning model (e.g., of the tracking system 102, or the organization computing system 104 as discussed further herein) trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

The tracking system 102 may be configured to communicate with the organization computing system 104 via network 105. For example, the tracking system 102 may be configured to provide the organization computing system 104 with a broadcast stream (or broadcast feed) of a game or event in real-time (e.g., instantaneously) or near real-time (e.g., in less than 30 seconds, less than 1 minute, less than 5 minutes, etc.) via the network 105. As an example, the tracking system 102 may provide one or more game files 110 in a first format (e.g., corresponding to a format based on the components of the tracking system 102). Alternatively, or in addition, the tracking system 102 or the organization computing system 104 may convert the broadcast stream (e.g., game files 110) into a second format, from the first format. The second format may be based on the organization computing system 104. For example, the second format may be a format associated with a data store 118, discussed further herein.

The organization computing system 104 may be configured to process the broadcast stream of the game. The organization computing system 104 may include at least a web client application server 113, a tracking data system 116, the data store 118, a play-by-play module 120, a prediction and insights module 122, a data stream and processing module 132, a display generation module 140, and/or a transmission module 142. Each of the tracking data system 116, the play-by-play module 120, the prediction and insights module 122, the data stream and processing module 132, the display generation module 140, and the transmission module 142 may be comprised of one or more software modules. The one or more software modules may be collections of code or instructions stored on a media (e.g., memory of the organization computing system 104) that represent a series of machine instructions (e.g., program code) that implements one or more algorithmic steps. Such machine instructions may be the actual computer code a processor of the organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

The tracking data system 116 may be configured to receive broadcast data from the tracking system 102 and generate tracking data from the broadcast data. In some embodiments, the tracking data system 116 may apply an artificial intelligence and/or computer vision system configured to derive player-tracking data from broadcast video feeds.

To generate the tracking data from the broadcast data, the tracking data system 116 may, for example, map pixels corresponding to each player and ball to dots and may transform the dots to a semantically meaningful event layer, which may be used to describe player attributes. For example, the tracking data system 116 may be configured to ingest broadcast video received from the tracking system 102. In some embodiments, the tracking data system 116 may further categorize each frame of the broadcast video into trackable and non-trackable clips. In some embodiments, the tracking data system 116 may further calibrate the moving camera based on the trackable and non-trackable clips. In some embodiments, the tracking data system 116 may further detect players within each frame using skeleton tracking. In some embodiments, the tracking data system 116 may further track and re-identify players over time. For example, the tracking data system 116 may re-identify players who are not within a line of sight of a camera during a given frame. In some embodiments, the tracking data system 116 may further detect and track an object across a plurality of frames. In some embodiments, the tracking data system 116 may further utilize optical character recognition techniques. For example, the tracking data system 116 may utilize optical character recognition techniques to extract score information and time remaining information from a digital scoreboard of each frame.

Such techniques assist in the tracking data system 116 generating tracking data from the broadcast feed (e.g., broadcast video data). For example, the tracking data system 116 may perform such processes to generate tracking data across thousands of possessions and/or broadcast frames. In addition to such process, the organization computing system 104 may go beyond the generation of tracking data from broadcast video data. Instead, to provide descriptive analytics, as well as a useful feature representation for the prediction and insights module 122 and/or the data stream and processing module 132, the organization computing system 104 may be configured to map the tracking data to a semantic layer (e.g., events). Further, in some embodiments, the tracking data system 116 may be configured to generate (or extract) excitement data from the broadcast feed (e.g., broadcast video data and/or audio data). Excitement data may include data representing one or more of video or graphics of excited fans attending the game at the venue 106, or audio data of fans clapping or cheering during the game at the venue 106.

The tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

The play-by-play module 120 may be configured to receive play-by-play data from one or more third party systems. For example, the play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, the play-by-play module 120 may utilize machine learning outputs and/or manually annotated data that may reflect the referee's ultimate adjudication. Such data may be referred to as the play-by-play feed.

To help identify events within the generated tracking data, the tracking data system 116 may merge or align the play-by-play data with the raw generated tracking data (which may include the game and time fields). The tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system 116 may be configured to perform various operations on the aligned tracking data. For example, the tracking data system 116 may use the play-by-play data to refine the player and ball positions and precise frame of the end of possession events (e.g., shot/rebound location). In some embodiments, the tracking data system 116 may further be configured to detect events (e.g., event data), automatically, from the tracking data. In some embodiments, the tracking data system 116 may further be configured to enhance the event data with contextual information.

For automatic event detection, the tracking data system 116 may include a neural network system trained to detect/refine various events in a sequential manner. For example, the tracking data system 116 may include an actor-action attention neural network system to detect/refine one or more of: shots, scores, points, rebounds, passes, dribbles, penalties, fouls, and/or possessions. The tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events (or event data) enables a player representation to be captured, to further build out the best possible player representation, the tracking data system 116 may generate contextual information to enhance the detected events. Exemplary contextual information may include defensive matchup information (e.g., who is guarding who at each frame, defensive formations), as well as other defensive information such as coverages for ball-screens or presses.

The data store 118 may be configured to store one or more game files 126, user data 127, templates 128, trigger events 129, story (or stories) 130, and/or sports information card(s) 131. Each game file 126 may include video data of a given match. For example, the video data may correspond to a plurality of video frames captured by the tracking system 102, the tracking data derived from the broadcast video as generated by the tracking data system 116, play-by-play data, and/or enhanced data. The game files 126 may be based, for example, on the game files 110 as discussed herein. The game files 126 may be in a different format than the game files 110. For example, a first format of the game files 110 or a subset thereof may be transformed into a second format of game files 126. The transformation may be performed automatically based on the type and/or content of the first format and the type and/or content of the second format.

The user data 127 may include data associated with one or more users of the client device 108. For example, the user data 127 may include one or more user attributes such as user preference (or affinity) data (e.g., a user's preferred sport(s), sports team(s), sports league(s), sports club(s), sports event(s), sports competition(s), player(s), or the like), user behavioral data (e.g., a user's browsing history, the amount of time or dwell time a user has spent viewing or interacting with one or more webpages, websites, applications, or sports media content, a user's past engagement with interactive elements such as advertisements, market-based prediction offers, questionnaires, games, or the like), user profile data, or data that a user of the client device 108 has shared with the organization computing system 104.

In addition or in the alternative, the user data 127 may include data representing a historical or current level of engagement of a particular user and/or other users (e.g., of the client device(s) 108 or other devices), with sports media content, sports media stories, sports information cards, interactive elements, and/or other content. For example, the user data 127 may include data representing teams that one or more users followed, likes of one or more users, content shared by one or more users, comments posted by one or more users, videos viewed in part or in full by one or more users, and/or videos of replays viewed in part or in full by one or more users. As another example, the user data 127 may include data representing accounts (e.g., associated with teams or players) that one or more users follow and/or the interactions of the one or more users with the content of such accounts. As another example, the user data 127 may include data representing a level of excitement or enthusiasm of one or more users, keyword(s) and/or hashtag(s) that one or more users have searched for, music or audio clips included in content that one or more users have engaged with, and/or specific effect(s) or filter(s) that align with the preferences of one or more users (e.g., based on historical data). As another example, the user data 127 may include data representing the type of device(s) that one or more users use (e.g., mobile devices, laptops, or other computing devices), settings of the device(s) and/or account(s) of one or more users such as a language preference (e.g., the language of a user's account and device) and/or a location of the device(s) of one or more users (e.g., a general location, such as a country, determined based on an Internet Protocol address). As another example, the user data 127 may include data representing the amount of time (or duration) that one or more users spend viewing content (where content that is viewed or played in its entirety by one or more users may represent content of higher interest or higher relevance to the one or more users, whereas content that one or more users quickly skip through may represent content of lower interest or lower relevance to the one or more users). As another example, the user data 127 may include data representing sports media content and/or other content that is trending or being prioritized (e.g., based on cohort data or the data of one or more users). As yet another example, the user data 127 may include data representing the browsing history or content that one or more users have already viewed, and optionally data regarding the diversity or variance of the browsing history or content that one or more users have already viewed.

The templates 128 may include one or more templates (e.g., requirements, formats, layouts, models, samples, or guides) for sports media content (e.g., sports media stories). In some aspects, a template 128 may define what content (e.g., one or more graphics, notifications, images, video, audio, text, interactive elements) is to be presented or played, how the content is to be presented or played, and/or when the content is to be presented played, in or adjacent to a sports media story, for example. In some embodiments, a template 128 may be determined by, or customized for, an entity associated with the third entity system 170 (e.g., a sports news company associated with the third entity system 170). For example, a sports news company may determine that the content of a template 128 should reflect the sports news company's brand (e.g., trademark, logo, and/or certain colors, sounds, or graphics) or a particular look and feel. In some embodiments, a template 128 may specify one or more insights (e.g., metrics, facts, predictions displayed using text and/or graphics) such as the leading or highest performing player of a game, particular game statistic(s), a line-up, goal(s), pass(es), expected goal(s), or expected pass(es). Further, in some embodiments, a template 128 may specify one or more graphics such as a goal-sequence or a heat map, and/or the formatting of one or more graphics (e.g., landscape or portrait mode, resolution, or the like). Further, in some embodiments, a template 128 may be associated with one or more trigger events 129, such that if the occurrence of one or more of the trigger events 129 is detected in tracking data and/or event data (e.g., output from the tracking system 102 and/or the tracking data system 116), the template 128 is to be automatically applied to generate sports media content (e.g., a sports media story). For example, a template 128 may be associated with a trigger event 129 representing a goal that is scored, such that if occurrence of the trigger event 129 is detected in tracking data and/or event data, the template 128 may be automatically applied (or populated or filled) to generate a sports media story that includes or is adjacent to (e.g., in an interactive display) a particular advertisement or market-based prediction offer. In some embodiments, a template 128 may specify that a sports media story is to include an interactive element (e.g., an advertisement or market-based prediction offer) that is relevant (or corresponds to or matches) user data 127 such that the sports media story including the interactive element is customized (or personalized) for a user associated with the user data 127 (e.g., a user of a client device 108, who will view the sports media story).

The trigger events 129 may include data representing one or more events or types (or categories) of events. When the occurrence of the one or more events or types of events is detected in tracking data, event data, a post-game summary, or other data (e.g., by the tracking system 102, the tracking data system 116, the prediction and insights module 122, or the data stream and processing module 132) corresponding sports media content (e.g., a sports media story) may be generated. In some embodiments, a trigger event 129 may represent a natural language prompt (e.g., “Generate a story regarding Lebron James.”) received from, for example, the client device 108 or the third entity system 170. In some aspects, when the occurrence of a trigger event is detected, a corresponding (or associated) sports media content (e.g., a sports media story) may be generated using, for example, one or more of the prediction and insights module 122, the data stream and processing module 132, and a template 128. In some embodiments, a trigger event 129 may represent, for example, a particular game statistic, metric, or feature (e.g., a particular number of goals, points, hits, or touchdowns, an expected number of goals, hits, points, or touchdowns, an expected possession, a line-up, a first half kickoff, a time representing half time, a time representing full time, a probability of a win, a kick off, a level of fans' excitement determined from excitement data, or the like). In some embodiments, one or more trigger events 129 may be pre-determined (e.g., manually defined in advance by an entity associated with the organization computing system 104, or an entity associated with the third entity system 170). Further, in some embodiments, the one or more trigger events 129 may be dynamically determined using, for example, a second machine learning model 134 of the data stream and processing module 132. In some embodiments, tracking data, event data, a post-game summary, or other data may be analyzed continuously or periodically (e.g., at a certain frequency) by one or more of the tracking system 102, the tracking data system 116, the prediction and insights module 122, or the data stream and processing module 132, to detect or identify the occurrence of one or more trigger events 129. In some embodiments, a trigger event 129 may be associated with (e.g., correspond to) one or more templates 128.

The story (or stories) 130 may include data representing one or more sports media stories (or visual elements). In some aspects, a story 130 may include one or more of an image, video, audio, text, and/or an interactive element. In some embodiments, a story 130 may be generated by the data stream and processing module 132 (optionally using a template 128) or the display generation module 140.

The sports information card(s) 131 may include one or more distinct sets of data, where each distinct set of data may include event data, tracking data, statistics, summaries, and/or the like, configured to be presented in graphical or textual (e.g., dialogue) form within a sports content stream (or user interface). In some embodiments, a sports information card 131 may be generated by the data stream and processing module 132 or the display generation module 140.

The prediction and insights module 122 may be configured to generate or determine one or more predictions (e.g., probabilities or statistics) or insights (e.g., metrics, facts, or the like). For example, the prediction and insights module 122 may be configured to determine an expected number of goals or a probability of a team winning a game. In some embodiments, the prediction and insights module 122 may include one or more prediction models (e.g., machine learning models) configured to accurately generate predictions or insights based on, for example, tracking data and/or event data received from the tracking system 102 or the tracking data system 116. In some embodiments, the one or more prediction models may be trained using game files or simulated game files from historical games, historical tracking data, historical event data, simulated games, historical or simulated feature representations, user data representing historical interest levels, engagement levels, or dwell times with particular predictions or insights, and/or the like. Further, in some embodiments, the prediction and insights module 122 may be configured to generate or determine one or more predictions or insights (i) representing (or associated with) the occurrence of a dynamically determined trigger event 129 and/or (ii) to comply with a corresponding template 128 being applied by the data stream and processing module 132 to generate sports media content (e.g., a sports media story).

The data stream and processing module 132 may be an embodiment of the data stream module 104 described in U.S. Provisional Patent Application No. 63/549,225, filed on Feb. 2, 2024, and U.S. Provisional Patent Application 63/554,426, filed on Feb. 16, 2024, both of which are incorporated by reference herein. In some embodiments, the data stream and processing module 132 may be configured to receive tracking data, event data, or other data (e.g., a broadcast stream or excitement data) from the tracking system 102, the tracking data system 116, the data store 118, or the data store 114. The data stream and processing module 132 may also be configured to receive user data 127 and/or templates 128 from the data store 118. The data stream and processing module 132 may further be configured to receive one or more predictions or insights from the prediction and insights module 122. In addition, the data stream and processing module 132 may be configured to receive one or more natural language (e.g. text) prompts from the third entity system 170 or the client device 108.

In some embodiments, the data stream and processing module 132 may be configured to determine if the occurrence of one or more pre-defined trigger events 129 is detected in one or more of tracking data, event data, broadcast data, or excitement data, that the data stream and processing module 132 receives. Further, in some embodiments, in response to detecting the occurrence of one or more trigger events 129, the data stream and processing module 132 may use one or more templates 128 associated with the one or more detected trigger events 129 to form or generate one or more sports media stories. For example, in response to detecting the occurrence of a trigger event 129, the data stream and processing module 132 may analyze a template 128 associated with the detected trigger event 129 to extract data from, for example, one or more of tracking data, event, data, a post-game summary, a prediction, or an insight, and format the extracted data in accordance with the template 128 to generate a sports media story. The data stream and processing module 132 may further transmit the sports media story to the data store 118 for storage as a story 130.

In some embodiments, and as shown in FIG. 1, the data stream and processing module 132 may include a first machine learning model 133, a second machine learning model 134, and a third machine learning model 135. In some embodiments, in response to detecting the occurrence of one or more trigger events 129, the first machine learning model 133 may be configured to receive data including one or more of tracking data, event data, broadcast data (e.g., video data and/or audio data), or user data 127, and generate (i) a graphic configured to be converted into a story or (ii) a story, based on the received data. Further, in some embodiments, in response to receiving a natural language prompt from the client device 108 or the third entity system 170, the first machine learning model 133 (e.g., a generative machine learning model) may be configured to generate (i) a graphic configured to be converted into a story or (ii) a story, based on the received natural language prompt. In some embodiments, the first machine learning model 133 may be trained to optimize the generation of content (for a graphic configured to be converted into a story, for a story, or for a display), based on user data 127 for a respective user (e.g., of the client device 108), where weights of the first machine learning model 133 are determined to increase user engagement with the content as determined based on the respective user's user data 127.

As explained above, in some embodiments, the data stream and processing module 132 may be configured to output a graphic configured to be converted into a story. In such embodiments, the graphic may include one or more of text data, image data, video data, audio data, or interactive elements. To convert the graphic into the story, the data stream and processing module 132 may, for example, integrate, associate, or augment the graphic with other data (e.g., other text data, image data, video data, audio data, or interactive elements). For example, the data stream and processing module 132 may insert or embed one or more interactive elements in the graphic to form a story, or configure the graphic to be positioned above, below, or to the side of one or more interactive elements within a user interface (e.g., an interactive display or content stream). Further, in some embodiments, the data stream and processing module 132 may insert or embed a clip or segment of video (e.g., output from the third machine learning model 135 and representing a highlight of a game) in the graphic to generate a story.

In some embodiments, the data stream and processing module 132 may request an interactive element associated with (e.g., corresponding or related to) the graphic and/or user data 127 from the first entity system 150 or the second entity system 160, and subsequently receive the requested interactive element from the first entity system 150 or the second entity system 160, for insertion in a graphic to form a story, or for positioning adjacent to the graphic or story within a user interface. For example, where a story is to be provided to a user of the client device 108, the data stream and processing module 132 may retrieve an interactive element (e.g., an advertisement or market-based prediction offer) that similar to an interactive element the user has previously engaged with (as indicated via the user data 127), or that involves subject matter similar, related, or identical to that in the graphic, and integrate the received interactive element with the graphic to form the story. As another example, where a story includes data regarding a particular player, the data stream and processing module 132 may retrieve, from the second entity system 160, a market-based prediction offer that includes predictions or a market prediction slip regarding the player for insertion in the story or positioning adjacent to the story within a user interface. As another example, where a story includes data regarding a particular player, the data stream and processing module 132 may retrieve, from the first entity system 150, an advertisement or coupon associated with (or that facilitates) buying a product or service related to the player (e.g., shoes the player is wearing during the game). In some embodiments, the advertised product or coupon may be tailored to a user of the client device 108 based on the user's apparel size and/or geographic location (e.g., as indicated in user data 127). Further, in some embodiments, the retrieved advertisement or coupon may be based on the outcome of a game and facilitate the purchase of, for example, tickets to a subsequent game, merchandise related to one or more players of the game, or the like. In some embodiments, a user of the client device 108 may be able to make one or more purchases, rentals, or market predictions directly within an interactive element integrated within a story or positioned adjacent to the story (e.g., optionally where the user is simultaneously logged into a computer system or environment associated with the interactive element, the first entity system 150, or the second entity system 160). In some other embodiments, a user of the client device 108 may be able to make one or more purchases, rentals, or market predictions by (i) selecting an interactive element integrated within a story or positioned adjacent to the story, and (ii) then being navigated to another webpage, website, or application to conduct or complete the purchases, rentals or market predictions.

In some aspects, where the first machine learning model 133 outputs a graphic that is converted to a story (or outputs a story), the story may be saved in the data store 118 as a story 130. Further, in some embodiments, the first machine learning model 133 may be configured to output (i) a graphic configured to be converted to a sports information card or (ii) a sports information card, in a manner similar to that described above with respect to a story. The first machine learning model 133 may also be configured to transmit such a sports information card to the data store 118 for storage as a sports information card 131.

In some aspects, the first machine learning model 133 may be trained using training data. The training data may include, for example, one or more of game files or simulated game files from historical games, historical tracking data, historical event data, historical broadcast data, historical interactive elements, historical user data, historical templates, historical stories, historical sports information cards, historical natural language prompts, simulated games or other data, historical or simulated trigger events, historical or simulated graphics, historical or simulated feature representations, and/or the like. In some embodiments, the first machine learning model 133 may be dynamically trained (e.g., trained on the fly).

The second machine learning model 134 may be configured to output (or dynamically determine or generate) a trigger event. In some embodiments, the second machine learning model 134 may be configured to receive excitement data or other data as input, and dynamically determine a trigger event based on the received input data. The second machine learning model 134 may be configured to transmit the output trigger event to the data store 118 for storage as a trigger event 129. In some embodiments, the second machine learning model 134 may represent (or include) a generative machine learning model. In some aspects, the second machine learning model 134 may be trained using training data such as historical trigger events, simulated trigger events, historical games, historical tracking data, historical event data, historical broadcast data, historical interactive elements, historical user data, historical templates, historical stories, historical sports information cards, historical natural language prompts, simulated games or other data, historical or simulated feature representations, and/or the like. In some embodiments, the second machine learning model 134 may be dynamically trained (e.g., trained on the fly).

The third machine learning model 135 may be configured to output (or dynamically select or generate) a clip or segment of a broadcast feed (e.g., video data integrated with audio data). In some embodiments, the clip or segment of broadcast feed represents a portion (e.g., highlight) of a game that is associated with a sports media story (or a sports information card) generated, or to be generated, by the data stream and processing module 132 (e.g., the first machine learning model 133). For example, the clip or segment of broadcast feed may depict a segment of a game in which a player scores a goal, and the clip or segment of the broadcast feed may be configured to be integrated in a story related to the goal (e.g., as a video that automatically plays when the story is displayed in a user interface, or as a link that may be selected by a user of the client device 108 to subsequently view the video). In some embodiments, in response to the organization computing system 104 detecting the occurrence of a trigger event 129, the third machine learning model 135 may be configured to receive a broadcast feed (e.g., from the tracking system 102, the tracking data system 116, the data store 114, or the data store 118), and output a clip or segment of the broadcast feed based on the received input. In some aspects, the third machine learning model 135 may be trained using training data such as historical broadcast feeds, historical clips of broadcast feeds, simulated broadcast feeds, simulated clips of broadcast feeds, historical games, historical tracking data, historical event data, historical user data, historical templates, historical stories, historical sports information cards, historical natural language prompts, simulated games or other data, historical or simulated feature representations, and/or the like. In some embodiments, the third machine learning model 135 may be dynamically trained (e.g., trained on the fly).

As explained above, in various embodiments, the data stream and processing module 132 may be configured to receive a plurality of event data, match (e.g., game) data, user data, content, advertisements, and/or live stream or streaming audio/video data. The data and other aspects may be gathered and/or compiled by the organization computing system 104 or using components separate from computing environment 100. In examples, match data and/or event data may include actions taken by a player(s) during a match/game that inform a generated interactive display. In various implementations, the data may be received by the data stream and processing module 132 almost simultaneous to an event action of a player occurring or, at least, substantially simultaneous to the event action taking place. The data may be received by organization computing system 104 over the network 105.

According to certain embodiments, the data stream and processing module 132 may receive in-venue or broadcast data associated with a sporting event. Such in-venue or broadcast data may be used to generate the event data discussed herein. For example, such in-venue or broadcast data may be provided to one or more event machine learning models. The one or more event machine learning models may be trained based on training data that includes historical or simulated in-venue or broadcast data, historical or simulated event data (e.g., tagged data), historical or simulated event actions, and/or the like. The training data may be used to train the event machine learning models by modifying one or more weights, layers, synapses, biases, and/or the like of the event machine learning models, in accordance with a machine learning algorithm, as discussed herein. Alternatively, or in addition, such in-venue or broadcast data may supplement received event data for verification and/or use to generate an interactive display.

The display generation module 140 may be an embodiment of the display generation module 106 described in U.S. Provisional Patent Application No. 63/549,225, filed on Feb. 2, 2024, and U.S. Provisional Patent Application 63/554,426, filed on Feb. 16, 2024, both of which are incorporated by reference herein. In some embodiments, the display generation module 140 may be configured to generate an interactive display using data received by the data stream and processing module 132. The interactive display may represent an interactive user interface in which one or more sports media stories, interactive elements, or sports information cards are presented (e.g., within a content stream of the interactive display). In some embodiments, the display generation module 140 may be configured to embed, using one or more codes, one or more sports media stories, interactive elements, or sports information card in an interactive display. Further, in some embodiments, the display generation module 140 may use the API system 180 to integrate one or more sports media stories, interactive elements, or sports information cards, into an interactive display.

In some embodiments, the display generation module 140 may be configured to receive a graphic output from the first machine learning model 133 and convert the graphic into a sports media story or sports information card in a manner similar to that described above with respect to the data stream and processing module 132 (for integration in an interactive display). Further, in some embodiments, the display generation module 140 may be configured to receive a sports media story or sports information card output from the first machine learning model 133, for integration in an interactive display. The interactive display may include at least one of a graphical representation of one or more of the aspects described herein. In some embodiments, the interactive display may be generated in real-time as data is received (e.g., by the data stream and processing module 132 or the display generation module 140). Further, the display generation module 140 may generate an interactive display using, for example, HyperText Markup Language, Cascading Style Sheets, and JavaScript.

The transmission module 142 may be an embodiment of the web client app server 113 described herein, or the transmission module 108 described in U.S. Provisional Patent Application No. 63/549,225, filed on Feb. 2, 2024, and U.S. Provisional Patent Application 63/554,426, filed on Feb. 16, 2024, both of which are incorporated by reference herein. In some embodiments, the transmission module 142 may be configured to transmit an interactive display generated using the display generation module 140 to one or more of the client device 108 or the third entity system 170 for display on a display screen.

The client device 108 may be an embodiment of the user device 112 described in U.S. Provisional Patent Application No. 63/549,225, filed on Feb. 2, 2024, and U.S. Provisional Patent Application 63/554,426, filed on Feb. 16, 2024, both of which are incorporated by reference herein. In some aspects, the client device 108 may be in communication with the organization computing system 104 via the network 105. The client device 108 may be operated by a user. For example, the client device 108 may be a mobile device, a tablet, a desktop computer, or any computing system having the capabilities described herein. Users may include, but are not limited to, individuals such as subscribers, clients, prospective clients, or customers of an entity associated with the organization computing system 104, or individuals who have obtained, will obtain, or may obtain a product, service, or consultation from an entity associated with the organization computing system 104.

The client device 108 may include at least application 180. The application 180 may be representative of a web browser that allows access to a website or a stand-alone application. The client device 108 may access the application 180 to access one or more functionalities of the organization computing system 104. The client device 108 may communicate over the network 105 to request a webpage, for example, from the web client application server 113 of the organization computing system 104. For example, the client device 108 may be configured to execute the application 180 to access or receive an interactive display including, for example, one or more sports media stories or interactive elements, from the organization computing system 104. The content that is displayed using the client device 108 may be transmitted from the web client application server 113 (and/or the transmission module 142) to the client device 108, and subsequently processed by the application 180 for display through a graphical user interface (GUI) of the client device 108. In some embodiments, the client device 108 may be configured to receive, from a user, a natural language prompt, and transmit the natural language prompt to the organization computing system 104 (e.g., the first machine learning model 133).

As explained above, the client device 108 may communicate across the network 105. The client device 108 may be associated with a user, e.g., a user that is viewing and/or interacting with a generated interactive display, an administrator of one or more components of environment 100, and/or the like. In some aspects, the organization computing system 104 may communicate with one or more of the other components of the computing environment 100 across the network 105.

The client device 108 may be configured to enable a user to access and/or interact with other systems in the environment 100. For example, the client device 108 may be a computer system such as, for example, a desktop computer, a mobile device, a tablet, etc. In some embodiments, the client device 108 may include one or more electronic application(s), e.g., a program, plugin, browser extension, etc., installed on a memory of the client device 108. In some embodiments, the electronic application(s) may be associated with one or more of the other components in the computing environment 100. For example, the electronic application(s) may include one or more of system control software, system monitoring software, software development tools, etc.

The first entity system 150 may include a server system or other computing device associated with, for example, an advertising company, marketing department, other entity, or the like. In some aspects, the first entity system 150 may be configured to enable an advertising company (or marketing department, etc.) to interact with other systems, such as the client device 108, the second entity system 160, the third entity system 170, the API system 180, the data store 114, and/or the organization computing system 104, in the computing environment 100. For example, in some embodiments, the first entity system 150 may be configured to transmit one or more interactive elements (e.g., advertisements, coupons, or the like) to the organization computing system 104 for integration in a sports media story or interactive display. Further, in some embodiments, the first entity system 150 may be configured to transmit one or more interactive elements to the organization computing system 104 in response to receiving a request for the one or more interactive elements from the organization computing system 104.

The second entity system 160 may include a server system or other computing device associated with, for example, a sports market prediction company or other entity. In some aspects, the second entity system 160 may be configured to enable a sports market prediction company (or the like) to interact with other systems, such as the client device 108, the first entity system 150, the third entity system 170, the API system 180, the data store 114, and/or the organization computing system 104, in the computing environment 100. For example, in some embodiments, the second entity system 160 may be configured to transmit one or more interactive elements (e.g., market-based prediction opportunities, market-based prediction offers, market prediction slips, or the like) to the organization computing system 104 for integration in a sports media story or interactive display. Further, in some embodiments, the second entity system 160 may be configured to transmit one or more interactive elements to the organization computing system 104 in response to receiving a request for the one or more interactive elements from the organization computing system 104.

Third entity system 170 may include a server system or other computing device associated with, for example, a sports news company (e.g., ESPN), a sports media platform, a social media platform, other entity, or the like. In some aspects, the third entity system 170 may be configured to enable a sports news company (or other entity) to interact with other systems, such as the client device 108, the first entity system 150, the second entity system 160, the API system 180, the data store 114, and/or the organization computing system 104, in the computing environment 100. For example, in some embodiments, the third entity system 170 may be configured to determine one or more interactive elements for integration (or association) with a sports media story, and transmit the determined one or more interactive elements to the organization computing system 104 for the integration or association. In some embodiments, the third entity system 170 may further be configured to integrate one or more interactive elements into a sports media story or associate the one or more interactive elements with the sports media story. The third entity system 170 may further be configured to transmit the sports media story to the organization computing system 104 (e.g., for integration in an interactive display). Further, in some embodiments, the third entity system 170 may be configured to receive a natural language prompt (e.g., from a journalist of a sports news company), and transmit the natural language prompt to the organization computing system 104, where the natural language prompt requests that a specific or customized sports media story be generated.

The API system 180 may include a server or other computing device, and may be configured to interact with other systems, such as the client device 108, the first entity system 150, the second entity system 160, the third entity system 170, the data store 114, or the organization computing system 104, in the environment 100. The API system 180 may be configured to receive and respond to a request for information or the like. Further, in some embodiments, the API system 180 may be configured to receive one or more interactive elements (e.g., market-based prediction offers) and a graphic (or story) from the organization computing system 104 and integrate the one or more interactive elements with the graphic to generate a story, or associate the one or more interactive elements with a story. The API system 180 may further be configured to transmit the generated story, or story associated with the one or more interactive elements, to the organization computing system 104, or the client device 108 (e.g., for presentation within an interactive display).

The data store 114 (e.g., a database) may be an embodiment of the data store 118 described herein, and/or the data store 114 described in U.S. Provisional Patent Application No. 63/549,225, filed on Feb. 2, 2024, and U.S. Provisional Patent Application 63/554,426, filed on Feb. 16, 2024, both of which are incorporated by reference herein. The data store 114 may include a server system and/or a data storage system such as computer-readable memory such as a hard drive, flash drive, disk, etc. In some embodiments, the data store 114 may include and/or interact with the API system 180 for exchanging with, or transmitting data to, other systems, e.g., one or more of the other components of the computing environment 100. The data store 114 may include and/or act as a repository or source for storing event data, user data, a generated interactive display, output data, and the like (e.g., to be transmitted to a client device 108 or any of the other components of the computing environment 100).

In some embodiments, the components of the computing environment 100 may be associated with a common entity, e.g., a service provider, an account provider, or the like. For example, in some embodiments, the organization computing system 104 and the data store 114 may be associated with a common entity. In some embodiments, one or more of the components of the computing environment may be associated with a different entity than another. For example, organization computing system 104 may be associated with one entity (e.g., a service provider) while the data store 114 may be associated with another entity (e.g., a storage entity providing storage services to an entity associated with the organization computing system 104). The systems and devices of the computing environment 100 may communicate in any arrangement.

Although depicted as separate components in FIG. 1, it should be understood that a component or portion of a component in the computing environment 100 may, in some embodiments, be integrated with or incorporated into one or more other components. In another example, the organization computing system 104 may be integrated in a data storage system. The data storage system may be configured to communicate and/or receive/send data across the network 105 to other components of computing environment 100. In some embodiments, operations or aspects of one or more of the components discussed above may be distributed amongst one or more other components. Any suitable arrangement and/or integration of the various systems and devices of the computing environment 100 may be used.

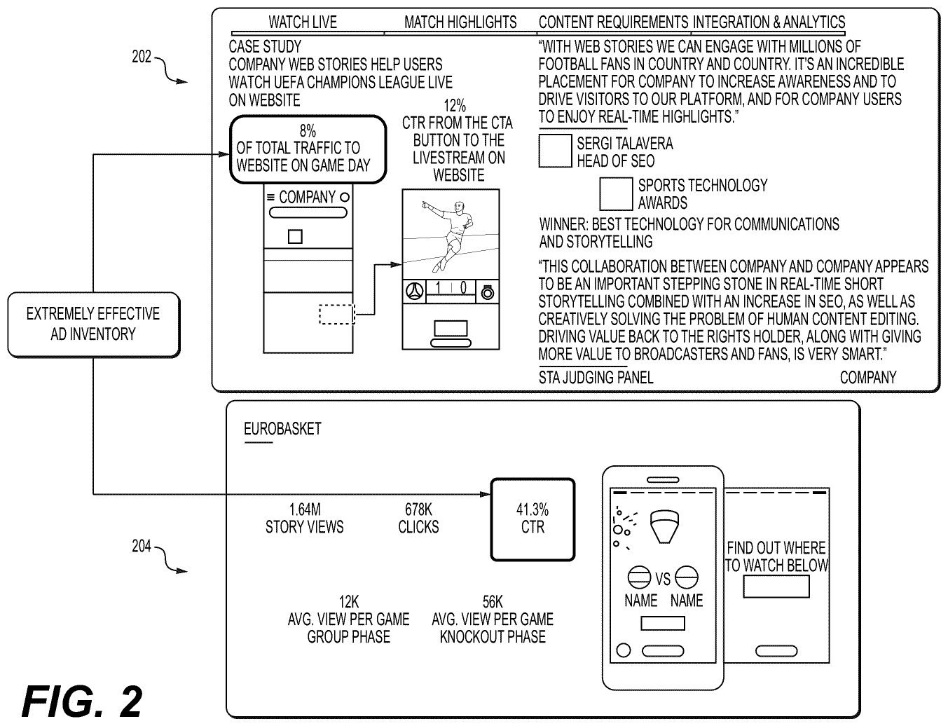

FIG. 2 depicts a graphical representations 202 and 204, which include key statistics related to the use of sports media stories to consume content. A sports media story may be graphical content related to sporting events that is displayed to and/or shared by a user with other users across a sports media platform and/or one or more social media platforms. The graphical content may be shared publicly or privately, and may include graphics (e.g., with statistics generated based on sporting events), video, audio, and other content, such as interactive content. A sports media story may have a predetermined length of time for which it is displayed or available to be viewed (e.g., one calendar day). Therefore, the content within the sports media story may be accessible only for a short period of time, as it may only be relevant to current sporting events. According to an embodiment, the duration of the availability of the sports media story may be automatically determined (e.g., by the organization computing system 104) based on a frequency of games associated with a given sport that corresponds to the story, an engagement level of one or more users with a given story, a relevance threshold, a user affinity associated with a given sporting event, team, player, or the like associated with the story, and/or the like.

In examples, the interactive display that is generated and displayed via a sports media story may pertain to a recent (e.g., within a time threshold) match/game. Advertisements may also be included in the interactive display that are relevant to the content, the time of sharing, and/or the user viewing the sports media story, and may allow the user to interact with the advertisement (e.g., leading the user to a website or platform outside of the sports media platform pertaining to the advertisement) or select an interactive component of the story to obtain more information about the advertisement. Similarly, one or more market-based prediction options may be included in the interactive display (e.g., as a story or a series of stories) that are relevant to the content, the time of sharing, and/or the user viewing the sports media story, and may allow the user to interact with the market-based prediction option to place a market prediction or select an interactive component of the story to obtain more information about the market-based prediction option.

As an example, a first story of a series of stories provided to a user of the client device 108 may be related to a statistic associated with a sporting event. A subsequent story may provide a market-based prediction option associated with the first story. The market-based prediction option of the subsequent story may be based on or related to the statistic provided via the first story.

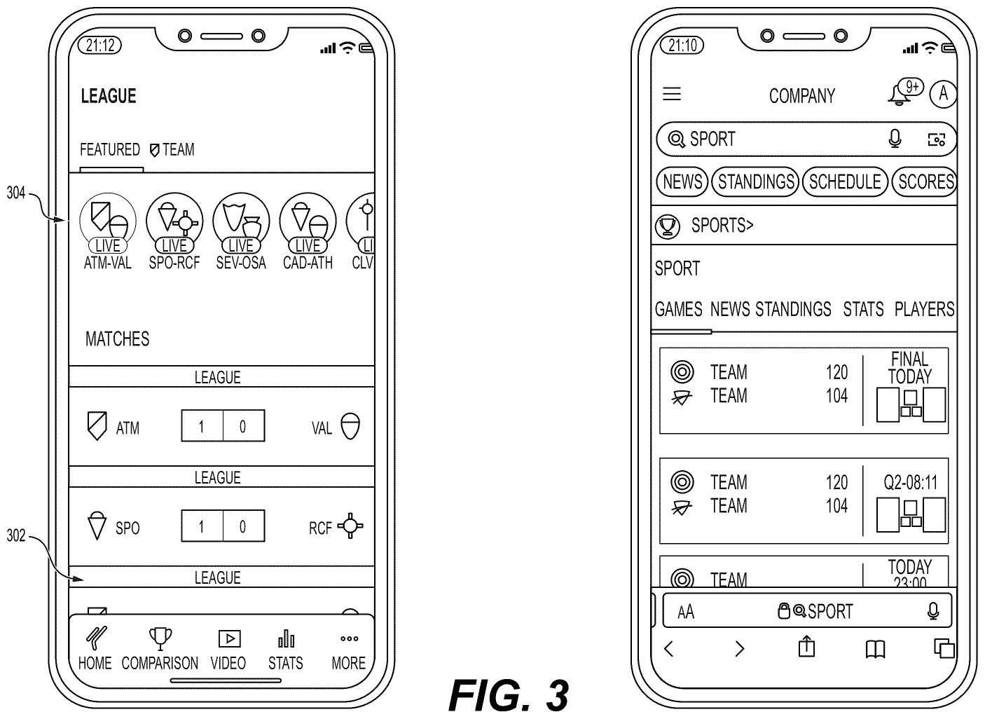

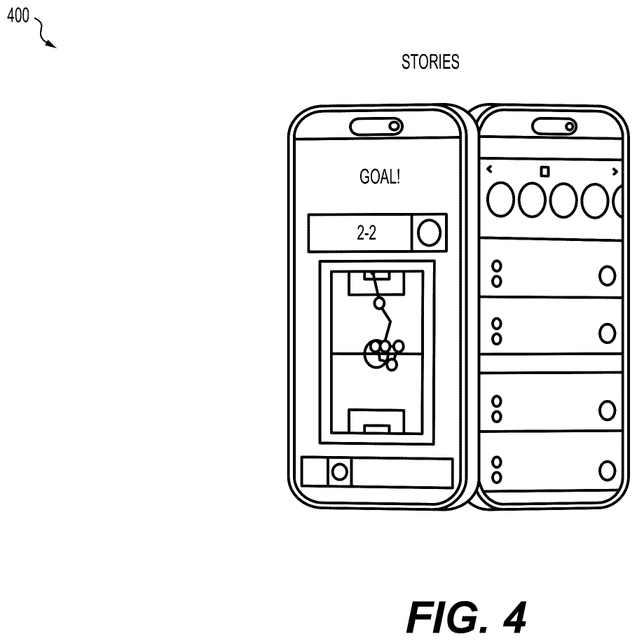

FIG. 3 depicts a user's sports media platform 302 display, including icons 304 to access the sports media stories discussed herein. Selection of an icon 304 associated with a sports media story may cause a sports media story to be displayed to a user (e.g., as shown in FIG. 4). As shown in FIG. 3, a user may be able to access a sports media stream (e.g., scrollable sports related content) and sports media stories via the same sports media platform. Selection of an icon 304 may trigger providing a series of sports media stories to a user such that each of the series of sports media stories is displayed in a sequential manner. Each story may be displayed for an amount of time associated with the sports media story, and different sports media stories may be displayed for different amounts of time. Sports media stories, as described above, may be interacted with (e.g., clicked on), to view the content of the story. Unlike other graphical interfaces that display a collection of match/game statistics, the interactive display described herein may include sports media stories within the display that have particular relevance to the user, to a user-selected data stream, to other content the user is viewing or has viewed, and/or to user preferences.

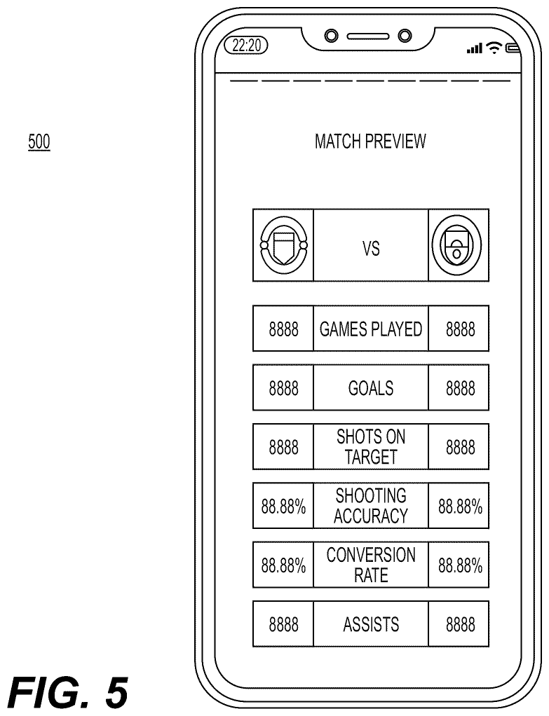

According to embodiments, sports event data or tracking data may be provided to a generative machine learning model (or the first machine learning model 133, for example). The generative machine learning model may be trained using training data such as a sports dictionary, broadcast commentary, historical or simulated sport event data or tracking data, historical or simulated analysis information, and or the like. The generative machine learning model may receive the sport event data and/or tracking data and may output a textual summary or analysis of such data. The output of the generative machine learning model may be automatically converted into sports media story and provided to a user via the sports media platform. Alternatively, or in addition, the output of the generative machine learning model may be converted into a graphic and provided via a sports media story. FIGS. 4-5 depict exemplary embodiments of various aspects of interactive displays 400 and 500, respectively. As illustrated in FIG. 4, statistics and/or graphics associated with event data or tracking data of a match/game may be provided as a sports media story via the interactive display 400 (e.g., a graphical user interface of a sports media platform). That event data or tracking data may be used to automatically generate the interactive display 400 provided as sports media stories that may include content, event data statistics, and/or summaries of event data or tracking data.

As illustrated in FIG. 5, a sports media story, when triggered via selection of an icon 304, may be displayed in the interactive display 500, on a user device. The sports media story may include real-time event data represented in graphical form (e.g., as output by a machine learning model, as discussed herein). Multiple sports media stories may be provided in continuous succession. Sports media stories may dynamically update based on event data or other data. For example, a first sports media story available to a user may be replaced by an updated sports media story (e.g., whether or not the user views the first sports media story). The first sports media story may be updated based on updated event actions associated with a sporting event. Accordingly, according to embodiments, a sports media story may automatically be removed or replaced if the content, statistics, graphics, or the like, associated with the story are outdated or inaccurate based on event actions associated with a sporting event.

The sports media story may include interactive elements such as advertisements. In various embodiments, an advertisement may be generated based on one or more sports media stories (e.g., based on a sporting event and/or based on user specific data, user interaction with a story, etc.) and may be inserted into a sequence of multiple sports media stories. In examples, the interactive display or sports media story may provide video that can include the streaming match/game and/or graphics, statistics, and/or insights related to the same. The graphics, statistics, and/or insights may be generated based on sports data (e.g., broadcast data/in-venue data). In other examples, a game summary may be displayed as content within the interactive display.

According to embodiments, a component (e.g., the organization computing system 104) of the computing environment 100 may receive broadcast footage of a sporting event. The computing environment 100 may generate raw broadcast tracking information and event data based on a plurality of data points from the raw broadcast tracking information. The computing environment 100 may then estimate additional data points of other players not in display from the broadcast capture to determine the locations and actions of other players on the field. Although broadcast tracking information is generally discussed herein, it will be understood that an in-venue system (e.g., using in-venue cameras) may provide one or more video feeds. Tracking data and event data may be extracted using a broadcast feed or in-venue feed.

Tracking data may include player and/or object position information, movement information, trends, changes, and/or the like. Event data may be annotated or tagged data that is annotated or tagged by a user or via a system. Such event data may include information such as an action (e.g., a pass, a goal, a type of sports activity, etc.), an event (e.g., a time based event such as the beginning or end of a quarter or half, possession time, etc.). According to embodiments, a diffuser may generate continuous (e.g., realistic) sporting event tracking and event data that algorithmically accounts for missing tracking and/or event data (e.g., due to occlusions).

A generative machine multimodal sports large language model (LLM) may be trained and/or have access to the tracking data, event data, and/or diffused tracking and event data. Accordingly, the multimodal sports LLM may be specifically trained using sports data and may generate outputs based on such sports data.

As discussed herein, a multimodal sports LLM may be trained using historical or simulated tracking and event data. The historical or simulated tracking and event data may be based on sporting events that are processed using broadcast and/or in-venue steams. Accordingly, the historical or simulated tracking and event data may correspond to sporting events and may include player and/or object position information, movement information, trends, changes, and/or the like. Such historical or simulated tracking and event data may be stored as tagged data, untagged data, tracking or event models, mathematical representations of associated data, and/or the like.

The following non-limiting example is introduced for discussion purposes. In the example, a system (e.g., the organization computing system 104) receives user input (e.g., from the client device 108 or the third entity system 170) for querying sporting event and accesses relevant database records (or data) from a database (e.g., the data store 114 or 118). The database records can include sports-related data associated with the sporting event such as player, team, and/or league related information. The system determines intentional and contextual information from the query. This information is then mapped to database records to generate sports tracking data based on the received query. The system can output the generated sports tracking data to the client device.

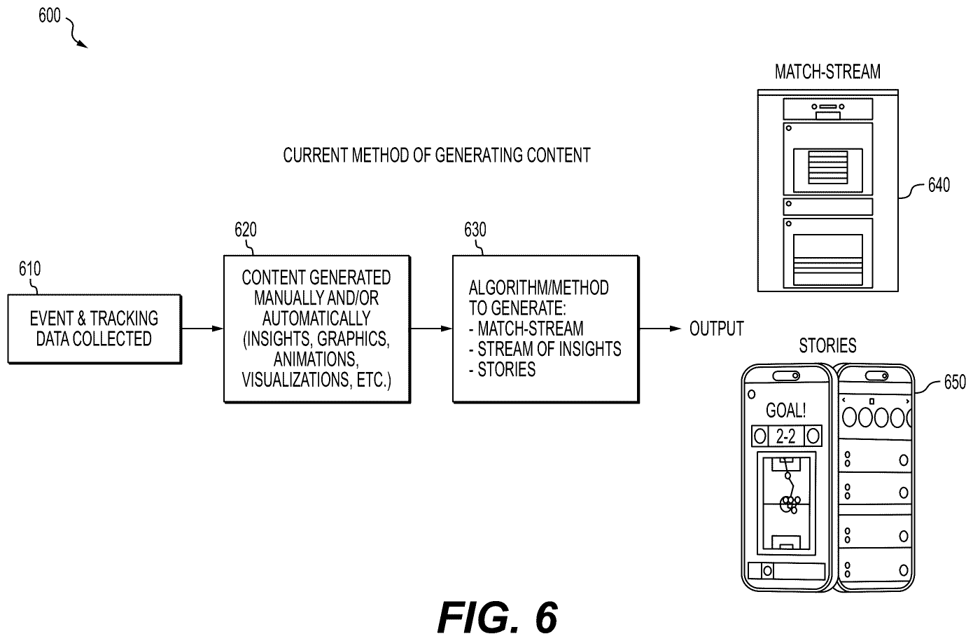

FIG. 6 depicts a flow diagram of a method 600 for generating an interactive display for a sports content data stream. In some embodiments, the method 600 may be performed by the organization computing system 104. The method 600 may be used to generate sports streams and stories content based on a previous or live game. At block 610, the method 600 may involve receiving sports event tracking data. This sports event tracking data may be from a database of sports tracking events previously gathered.

At block 620, the method 600 may involve generating content either automatically or manually. The content may be generated based on providing sports event tracking data to a machine learning model which may be trained to output sports related information such as sports related values, statistics, data, trends, or the like based on the input event tracking data. A content generation component may receive the output sports related information and may generate graphical content based on the same. Accordingly, the machine learning model may output relevant sports related information based on the input sports event tracking data such that the output sports related information may be temporally relevant to a user. For example, the output sports related information may include relevant scores, player statistics for a player playing a current or recent sporting event, team information, momentum information, etc.

In one example, the method 600 can automatically generate content based on previous or current user activity provided in the output sports information. In another example, the content may be generated based on user selection of at least some content from the database. Next at block 630, the method 600 may involve formulating, from the database records, a machine learning model prompt. The prompt can include one or more instructions, data, and preferences. Instructions can include preferences for one or more of a task, topic, style, tone, or format of the content. The prompt may be provided to a generative machine learning model that may be trained based on user preferences, past user interactions, a user profile, and/or the like. Accordingly, the prompt may be an input to the generative machine learning model that requests selection of content generated at block 620 such that the selection is relevant to a given user. The generative machine learning model may output a subset of the content generated at 620 for output to a user via a user device. At blocks 640 and 650, the method 600 may involve outputting content to a user device as a sports media stories and/or as sports information cards via a content stream. The output content may be selected by the generative machine learning model and may be updated based on updated sports event tracking data and/or user preferences.

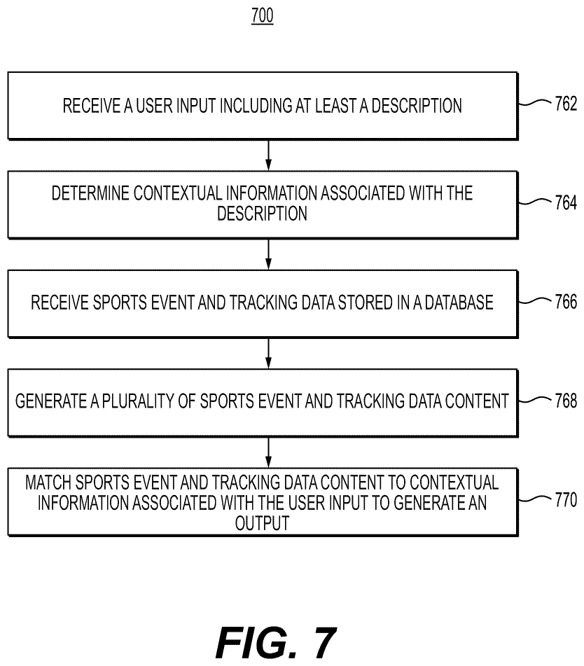

FIG. 7 depicts a flowchart 700 of a method for generating an interactive display for a sports content data stream. In some embodiments, the method of FIG. 7 may be performed by the organization computing system 104. At step 762, a user input including a description (e.g., query) may be received. The description may be received via a text input, an audio input, a video input, a drawing input, a gesture input, and/or the like. The user input may be a description request related to a sporting event, a team, a player, and/or the like. At step 764, contextual information associated with the description may be determined. As discussed herein, a generative machine learning model may receive the description as an input and may output the contextual information based on the description. The contextual information may be correlated with sporting event data and/or with content generated based on the sporting event data.

At step 766, sporting event and tracking data may be received and stored in a database. The sporting event and tracking data may be automatically generated based on a broadcast or in-venue feed and may include player and/or object position information, movement information, trends, changes, and/or the like.

At step 768, a plurality of sports event and tracking data content (e.g., graphics, statistics, displays, images, videos, etc.) may be generated based on the sports event and tracking data received at step 766. In addition, advertising and/or odds based content may also be generated based on user preferences and/or the sports event and tracking data received at step 766.

At step 770, sports event and tracking data content may be filtered by matching such content to the contextual information associated with the user input received at step 762. The matching may be performed by a machine learning model that receives, as inputs, the sports event and tracking data content, the contextual information, and/or user preference information. At step 770, a subset of the content generated at step 768 may be output to a user viewing a sports content stream. The sports content stream may include sports information cards and/or sports media stories that the user may passively consume or interact with (e.g., to access additional content, place a market prediction, access a webpage or application, etc.).

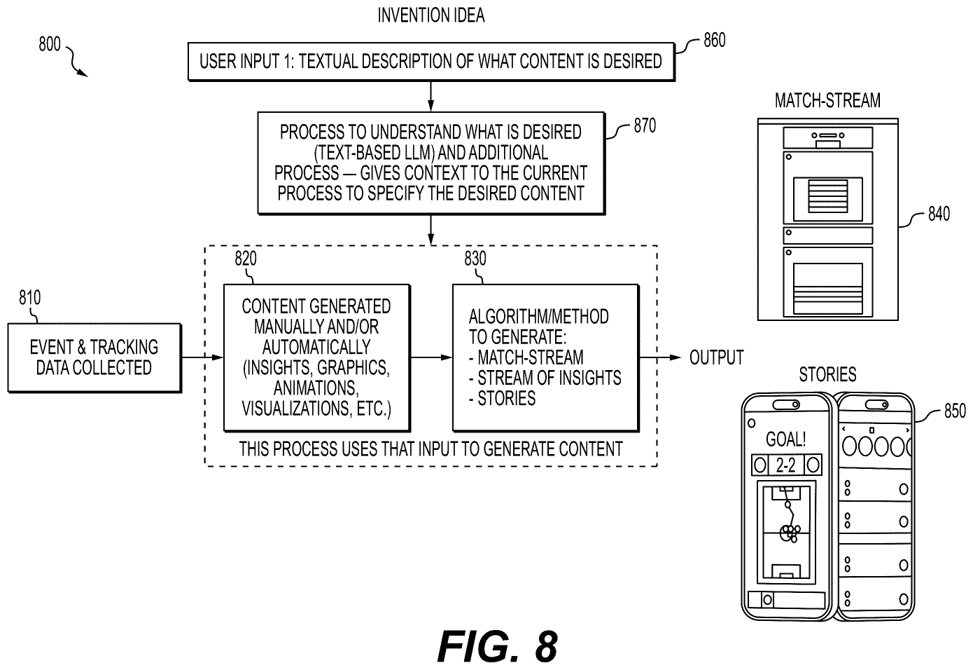

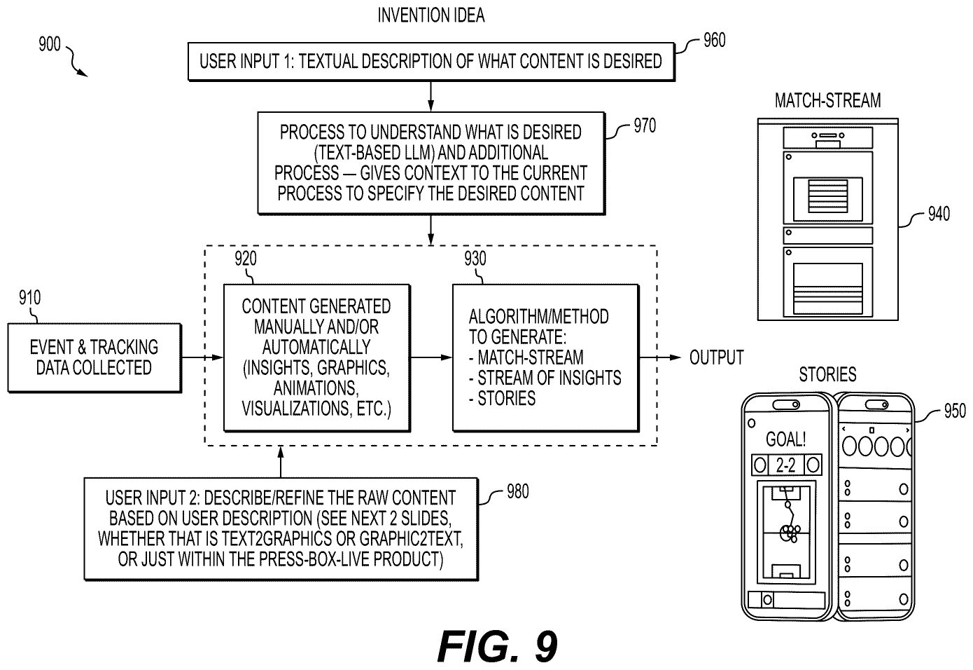

FIGS. 8 and 9 depict flow diagrams of methods 800 and 900, respectively, for generating an interactive display for a sports content data stream with additional user inputs. In some embodiments, each of the methods 800 and 900 (of FIGS. 8 and 9, respectively) may be performed by the organization computing system 104. FIGS. 8 and 9 depict some of the blocks as described in connection with FIG. 6, which will not be repeated here for brevity. Blocks 810, 820, 830, 840, and 850 of FIG. 8 correspond to blocks 610, 620, 630, 640, and 650, respectively. As shown in method 800, additional user inputs may be received at block 860. The method 800 may involve a user input to modify the content to be displayed in a stream or story. At block 860, the method 800 may involve a textual description of what content is desired by the user. The textual description may include, but is not limited to, team, player, event, action, play, etc. At block 870, method 800 may further involve a processing step to determine the context and/or intentions of the description inputted by the user. The system may determine the context and intention of the description based on keywords and/or tags found within the description using natural language processing techniques or a generative LLM model, as discussed herein. Blocks 820 and 830, consistent with 620 and 630 of method 600, may be implemented using additional information for determining the selection stream or story content for display. For example, content generated at block 820 may be generated, at least in part, based on the context and/or intentions determined at block 870. Further, for example, the content selected at block 830 to generate a stream or story may be selected, at least in part, based on the context and/or intentions determined at block 870. Finally, at blocks 840 and 850, method 800 may involve outputting content to a user device. The content may be displayed consistent with the prompt and additional information gathered from the user. For example, if the text input at block 860 indicates a story length, stories displayed at block 850 may have a duration corresponding to the story length. Although textual user inputs are generally discussed herein, it will be understood that a user may provide inputs via any applicable input technique such as, but not limited to, audio input, gesture input, augmented or virtual reality based inputs, video inputs, drawing inputs, etc. Similarly, although content streams are generally described as being provided using a screen of a user device, it will be understood that a content stream may be provided via television, a virtual reality and/or augmented reality head set, and/or the like.

As explained above, FIG. 9 depicts a flow diagram of a method 900 for generating an interactive display for a sports content data stream with additional user inputs. For brevity, blocks 910, 920, 930, 940, 950, 960, and 970 of FIG. 9 correspond to blocks 810, 820, 830, 840, 850, 860, and 870 of FIG. 8, respectively. The method 900 may include additional user inputs in comparison to method 800. At block 980, method 900 may involve an additional user input to define and/or refine the raw stream and/or story content based on additional descriptors. For example, the description received at blocks 860 and 960 may be in the form of text. The additional user inputs at block 980 may be in the form of text, graphics, or menu options within a user interface. This additional information is further used to define and refine the selection process of blocks 920 and 930. As an example, the input at block 980 may be provided by a user in response to a current content stream in an effort to further refine the current content stream to meet user preferences.

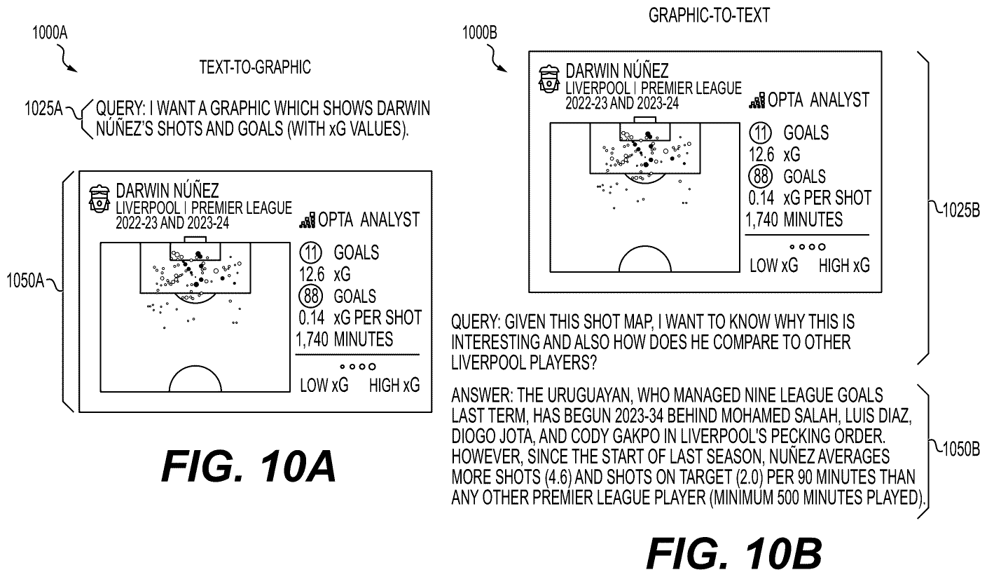

FIGS. 10A and 10B depict exemplary inputs and output displays of sports content data streams 1000A and 1000B, respectively, being presented to a user. FIGS. 10A and 10B relate to the additional user inputs at block 960 and/or block 980 of FIG. 9. For example, in FIG. 10A, a user may provide a query input 1025A (e.g., block 960) for specific content to be provided via the sports content data stream 1000A, and in response to entering the query input 1025A, a graphic 1050A may be displayed in the sports content data stream 1000A. As another example, the user may add an additional query at block 980, in response to a content stream the user is currently provided, to output a specific graphic with corresponding statistics. The input query may be a textual description, an audio query, a gesture-based query, and/or the like, and may request an output including a graphic displaying the requested information. In another example, FIG. 10B depicts a user including a text input and a graphic input as a query input 1025B, to request a textual output via the sports content data stream 1000B, and in response to entering the query input 1025B, a textual output 1050B may be displayed in the sports content data stream 1000B. The textual output 1050B may be generated by one or more machine learning models discussed herein based on sports event tracking data. In either example, the user can utilize a variety of additional inputs to further define and refine the displayed content.

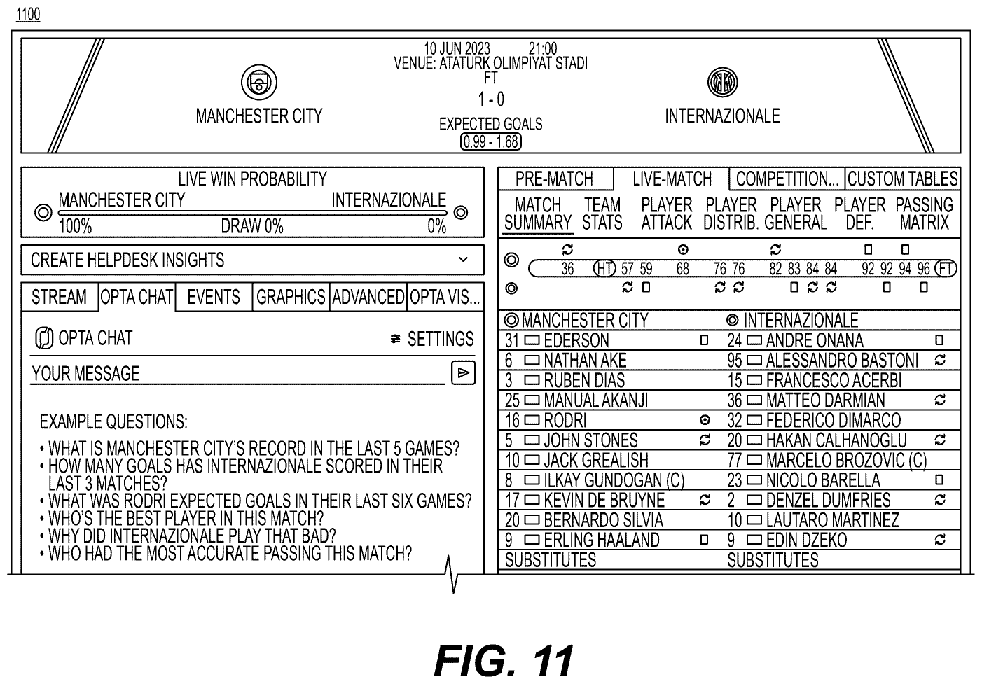

FIG. 11 depicts an exemplary input and output display of a sports content data stream 1100 being presented. Similar to FIGS. 10A and 10B, FIG. 11 relates to the additional user inputs at block 980 of FIG. 9. For example, FIG. 11 describes the use of an existing interface for the user to interact with to enter the additional refinement inputs. The user can interact with a series of user interface objects to define the content requested. In one example, the user can enter in textual information into a query (or chat) prompt of the user interface, and subsequently view a response (e.g., a chat response) to the textual information in the user interface. In another example, the user can select from different events to further refine the content. In another example, the user can select graphics from a predefined set of graphics for further refinement of the requested content.

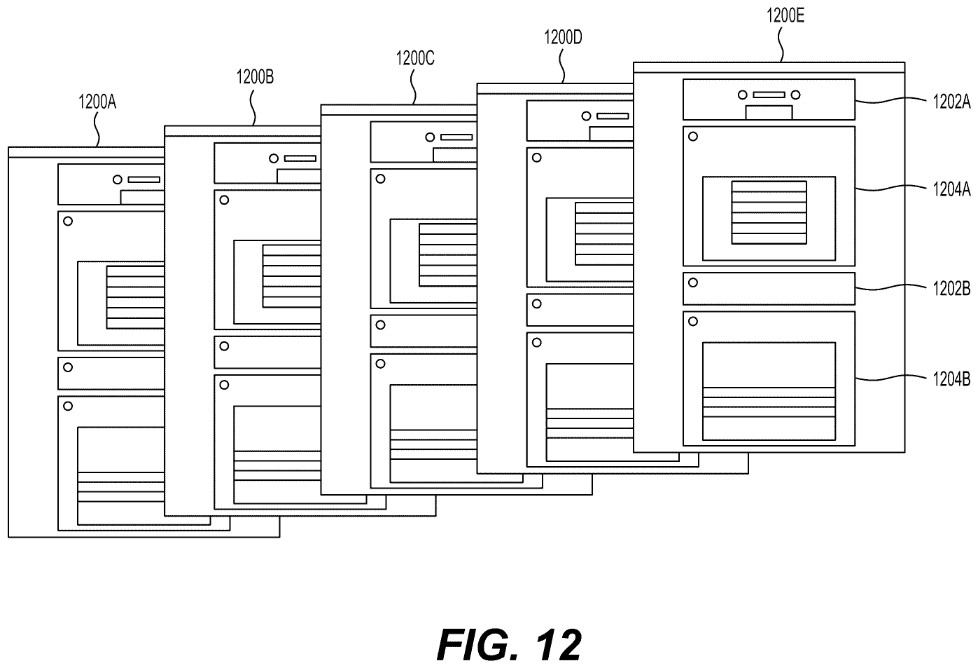

FIG. 12 depicts an exemplary series of recommended sports content data streams (e.g., content streams 1200A-E) for display based on user interactions. FIG. 12 depicts an exemplary scenario of a content stream being recommended to a user. The recommended content stream may be modified based on the user interactions with previous streams, content, requests, etc. The recommended content stream may continuously be modified by the system (e.g., the organization computing system 104) based on continuous user interactions, as discussed herein. As shown in FIG. 12, the content stream 1200E may include, for example, interactive elements 1202A and 1202B, and sports media stories (or sports information cards) 1204A and 1204B.

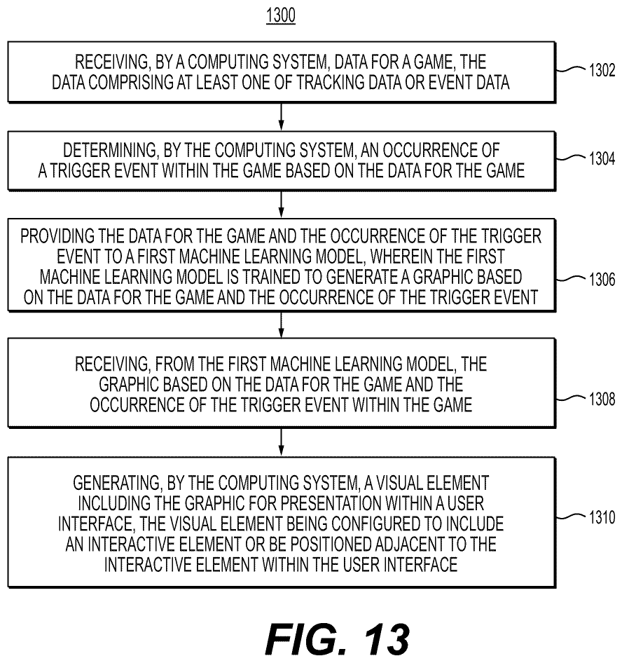

FIG. 13 depicts a flow diagram of a method 1300 for generating a sports media story. In some embodiments, the method 1300 may be performed by the organization computing system 104. As shown in FIG. 13, the method 1300 may include receiving, by a computing system (e.g., the organization computing system 104), data for a game, the data comprising at least one of tracking data or event data (1302).

The method 1300 may also include determining, by the computing system, an occurrence of a trigger event (e.g., a trigger event 129) within the game based on the data for the game (1304). In some embodiments, the trigger event may be a pre-determined trigger event type. Further, in some embodiments, the method 1300 may include dynamically determining, by the computing system and using a second machine learning model (e.g., the second machine learning model 134), the trigger event.

The method 1300 may include providing the data for the game and the occurrence of the trigger event to a first machine learning model (e.g., the first machine learning model 133), wherein the first machine learning model is trained to generate a graphic based on the data for the game and the occurrence of the trigger event (1306). In some embodiments, the graphic may be generated further based on one or more of user data (e.g., the user data 127), a statistic (e.g., a statistic generated by the prediction and insights module 122), or broadcast video data. Further, in some embodiments, the user data may represent one or more of user preference data or user behavioral data.

The method 1300 may include receiving, from the first machine learning model, the graphic based on the data for the game and the occurrence of the trigger event within the game (1308). The method 1300 may include generating, by the computing system, a visual element (e.g., a story 130) including the graphic for presentation within a user interface, the visual element being configured to include an interactive element or be positioned adjacent to the interactive element within the user interface (1310). In some embodiments, the visual element may be generated in less than 30 seconds. In some embodiments, the method 1300 may further include receiving the interactive element, where the interactive element represents at least one of a market-based prediction offer, an advertisement, a questionnaire, or a poll, and where the interactive element was selected based on one or more of the visual element, the graphic or user data. In some embodiments, the method 1300 may further include receiving, using the computing system, broadcast video data for the game; and determining, using a third machine learning model (e.g., the third machine learning model 135), a segment of the broadcast video data associated with the graphic, wherein the visual element includes the segment of the broadcast video data or a link to the segment of the broadcast video data. In some embodiments, the method 1300 may further include outputting, using a second machine learning model (e.g., of the tracking data system 116), the event data.

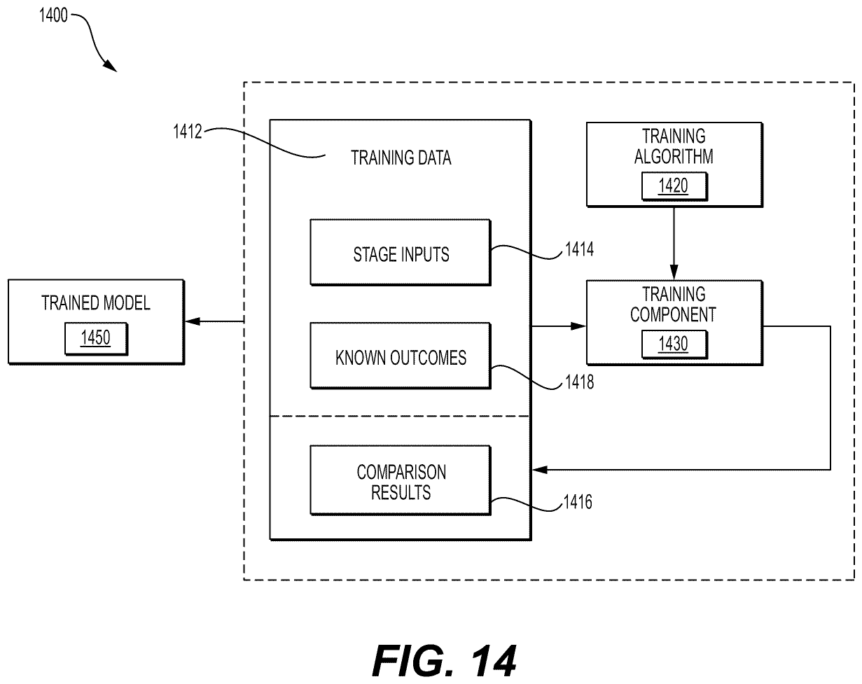

FIG. 14 depicts a flow diagram for training a machine learning model, in accordance with an aspect of the disclosed subject matter. As shown in flow diagram 1400 of FIG. 14, training data 1412 may include one or more of stage inputs 1414 and known outcomes 1418 related to a machine learning model to be trained. The stage inputs 1414 may be from any applicable source including a component or set shown in the figures provided herein. The known outcomes 1418 may be included for machine learning models generated based on supervised or semi-supervised training. An unsupervised machine learning model might not be trained using known outcomes 1418. Known outcomes 1418 may include known or desired outputs for future inputs similar to or in the same category as stage inputs 1414 that do not have corresponding known outputs.

The training data 1412 and a training algorithm 1420 may be provided to a training component 1430 that may apply the training data 1412 to the training algorithm 1420 to generate a trained machine learning model 1450. According to an implementation, the training component 1430 may be provided comparison results 1416 that compare a previous output of the corresponding machine learning model to apply the previous result to re-train the machine learning model. The comparison results 1416 may be used by the training component 1430 to update the corresponding machine learning model. The training algorithm 1420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1400 may be a trained machine learning model 1450.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

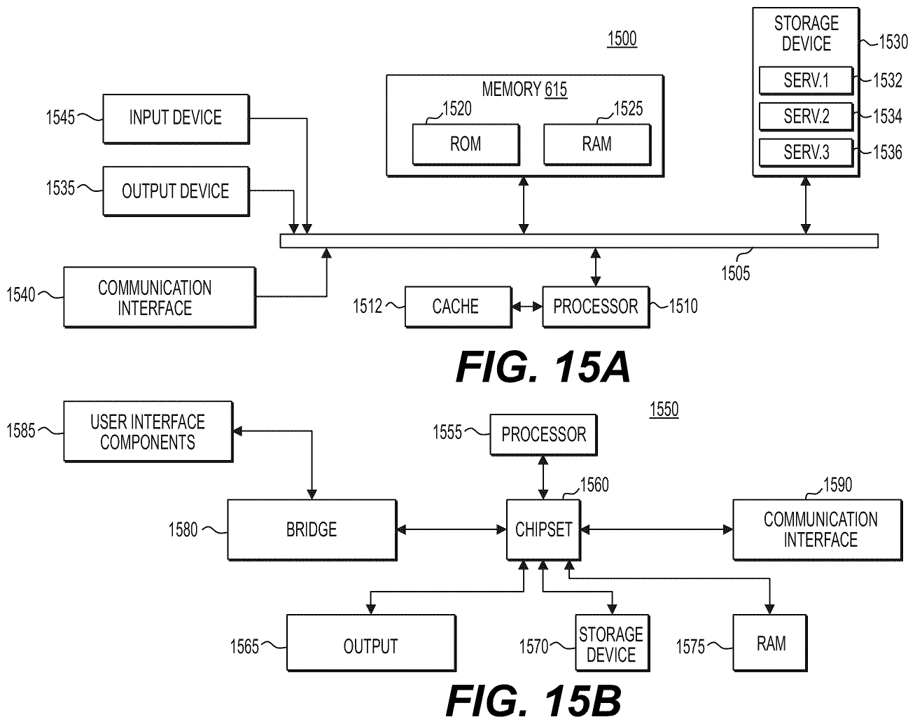

FIG. 15A illustrates an architecture of computing system 1500, according to example embodiments. System 1500 may be representative of at least a portion of organization computing system 104. One or more components of system 1500 may be in electrical communication with each other using a bus 1505. System 1500 may include a processing unit (CPU or processor) 1510 and a system bus 1505 that couples various system components including the system memory 1515, such as read only memory (ROM) 1520 and random access memory (RAM) 1525, to processor 1510. System 1500 may include a cache of high-speed memory connected directly with, in close proximity to, or integrated as part of processor 1510. System 1500 may copy data from memory 1515 and/or storage device 1530 to cache 1512 for quick access by processor 1510. In this way, cache 1512 may provide a performance boost that avoids processor 1510 delays while waiting for data. These and other modules may control or be configured to control processor 1510 to perform various actions. Other system memory 1515 may be available for use as well. Memory 1515 may include multiple different types of memory with different performance characteristics. Processor 1510 may include any general purpose processor and a hardware module or software module, such as service 1 1532, service 2 1534, and service 3 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction with the computing system 1500, an input device 1545 may represent any number of input mechanisms, such as a microphone for speech, a touch-sensitive screen for gesture or graphical input, keyboard, mouse, motion input, speech and so forth. An output device 1535 (e.g., display) may also be one or more of a number of output mechanisms known to those of skill in the art. In some instances, multimodal systems may enable a user to provide multiple types of input to communicate with computing system 1500. Communications interface 1540 may generally govern and manage the user input and system output. There is no restriction on operating on any particular hardware arrangement and therefore the basic features here may easily be substituted for improved hardware or firmware arrangements as they are developed.

Storage device 1530 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1525, read only memory (ROM) 1520, and hybrids thereof.

Storage device 1530 may include services 1532, 1534, and 1536 for controlling the processor 1510. Other hardware or software modules are contemplated. Storage device 1530 may be connected to system bus 1505. In one aspect, a hardware module that performs a particular function may include the software component stored in a computer-readable medium in connection with the necessary hardware components, such as processor 1510, bus 1505, output device 1535, and so forth, to carry out the function.

FIG. 15B illustrates a computer system 1550 having a chipset architecture that may represent at least a portion of organization computing system 104. Computer system 1550 may be an example of computer hardware, software, and firmware that may be used to implement the disclosed technology. System 1550 may include a processor 1555, representative of any number of physically and/or logically distinct resources capable of executing software, firmware, and hardware configured to perform identified computations. Processor 1555 may communicate with a chipset 1560 that may control input to and output from processor 1555. In this example, chipset 1560 outputs information to output 1565, such as a display, and may read and write information to storage device 1570, which may include magnetic media, and solid-state media, for example. Chipset 1560 may also read data from and write data to RAM 1575. A bridge 1580 for interfacing with a variety of user interface components 1585 may be provided for interfacing with chipset 1560. Such user interface components 1585 may include a keyboard, a microphone, touch detection and processing circuitry, a pointing device, such as a mouse, and so on. In general, inputs to system 1550 may come from any of a variety of sources, machine generated and/or human generated.

Chipset 1560 may also interface with one or more communication interfaces 1590 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1555 analyzing data stored in storage device 1570 or RAM 1575. Further, the machine may receive inputs from a user through user interface components 1585 and execute appropriate functions, such as browsing functions by interpreting these inputs using processor 1555.

It may be appreciated that example systems 1500 and 1550 may have more than one processor 1510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method comprising:
receiving, by a computing system, data for a game, the data comprising at least one of tracking data or event data;
determining, by the computing system, an occurrence of a trigger event within the game based on the data for the game;
providing the data for the game and the occurrence of the trigger event to a first machine learning model, wherein the first machine learning model is trained to generate a graphic based on the data for the game and the occurrence of the trigger event;
receiving, from the first machine learning model, the graphic based on the data for the game and the occurrence of the trigger event within the game; and
generating, by the computing system, a visual element including the graphic for presentation within a user interface, the visual element being configured to include an interactive element or be positioned adjacent to the interactive element within the user interface.

2. The method of claim 1, wherein the trigger event is a pre-determined trigger event type.

3. The method of claim 1, further comprising:
dynamically determining, by the computing system and using a second machine learning model, the trigger event.

4. The method of claim 1, wherein the graphic is generated further based on one or more of user data, a statistic, or broadcast video data.

5. The method of claim 4, wherein the user data represents one or more of user preference data or user behavioral data.

6. The method of claim 1, further comprising:
receiving, using the computing system, broadcast video data for the game; and
determining, using a second machine learning model, a segment of the broadcast video data associated with the graphic, wherein the visual element includes the segment of the broadcast video data or a link to the segment of the broadcast video data.

7. The method of claim 1, further comprising:
receiving the interactive element, wherein the interactive element represents at least one of a market-based prediction offer, an advertisement, a questionnaire, or a poll, wherein the interactive element was selected based on one or more of the visual element, the graphic, or user data.

8. The method of claim 1, further comprising:
outputting, using a second machine learning model, the event data.

9. The method of claim 1, wherein the visual element is generated in less than 30 seconds.

10. A non-transitory computer readable medium comprising one or more sequences of instructions, which, when executed by one or more processors, causes a computing system to perform operations comprising:
receiving, by the computing system, data for a game, the data comprising at least one of tracking data or event data;
determining, by the computing system, an occurrence of a trigger event within the game based on the data for the game;
providing the data for the game and the occurrence of the trigger event to a first machine learning model, wherein the first machine learning model is trained to generate a graphic based on the data for the game and the occurrence of the trigger event;
receiving, from the first machine learning model, the graphic based on the data for the game and the occurrence of the trigger event within the game; and
generating, by the computing system, a visual element including the graphic for presentation within a user interface, the visual element being configured to include an interactive element or be positioned adjacent to the interactive element within the user interface.

11. The non-transitory computer readable medium of claim 10, wherein the trigger event is a pre-determined trigger event type.

12. The non-transitory computer readable medium of claim 10, wherein the operations further comprise:
dynamically determining, by the computing system and using a second machine learning model, the trigger event.

13. The non-transitory computer readable medium of claim 10, wherein the graphic is generated further based on one or more of user data, a statistic, or broadcast video data.

14. The non-transitory computer readable medium of claim 13, wherein the user data represents one or more of user preference data or user behavioral data.

15. The non-transitory computer readable medium of claim 10, wherein the operations further comprise:
receiving, using the computing system, broadcast video data for the game; and
determining, using a second machine learning model, a segment of the broadcast video data associated with the graphic; and wherein the visual element includes the segment of the broadcast video data or a link to the segment of the broadcast video data.

16. The non-transitory computer readable medium of claim 10, wherein the operations further comprise:
receiving the interactive element, wherein the interactive element represents at least one of a market-based prediction offer, an advertisement, a questionnaire, or a poll, and wherein the interactive element was selected based on one or more of the visual element, the graphic, or user data.

17. The non-transitory computer readable medium of claim 10, wherein the operations further comprise:
outputting, using a second machine learning model, the event data.

18. The non-transitory computer readable medium of claim 10, wherein the visual element is generated in less than 30 seconds.

19. A computing system, comprising:
a processor; and
a memory having programming instructions stored thereon, which, when executed by the processor, causes the computing system to perform operations comprising:
receiving, by the computing system, data for a game, the data comprising at least one of tracking data or event data;
determining, by the computing system, an occurrence of a trigger event within the game based on the data for the game;
providing the data for the game and the occurrence of the trigger event to a first machine learning model, wherein the first machine learning model is trained to generate a graphic based on the data for the game and the occurrence of the trigger event;
receiving, from the first machine learning model, the graphic based on the data for the game and the occurrence of the trigger event within the game; and
generating, by the computing system, a visual element including the graphic for presentation within a user interface, the visual element being configured to include an interactive element or be positioned adjacent to the interactive element within the user interface.

20. The computing system of claim 19, wherein the operations further comprise:
dynamically determining, by the computing system and using a second machine learning model, the trigger event.
